(19) United States
(12) Patent Application Publication
(10) Pub. No.: US 2006/0120290 A1
(43) Pub. Date: Jun. 8, 2006

(54) Method for adapting the bitrate of a digital signal dynamically to the available bandwidth, corresponding devices, and corresponding computer-program product

(75) Inventors: Luigi Della Torre, Lissone (IT); Andrea Lorenzo Vitali, Bergamo (IT); Amedeo Enrico Zuccaro, Nebbiuno (IT)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics S.r.l., Agrate Brianza (IT)

(21) Appl. No.: 11/269,127

(22) Filed: Nov. 8, 2005

(30) Foreign Application Priority Data
Nov. 9, 2004 (IT) TO2004A000781

(51) Int. Cl. H04J 1/16; H04J 3/22; H04J 3/18

(52) U.S. Cl. 370/235; 370/477; 370/465

(57) ABSTRACT

The bitrate of a digital signal is adapted in a dynamic way to the bandwidth available on a transmission channel, through the operations of: converting the digital signal into a multiple-description format, so as to have available a plurality of descriptions of the digital signal; and transmitting on the transmission channel descriptions of the digital signal chosen from among said plurality of multiple descriptions, the number of the transmitted descriptions being determined as a function of the bandwidth available on the transmission channel.

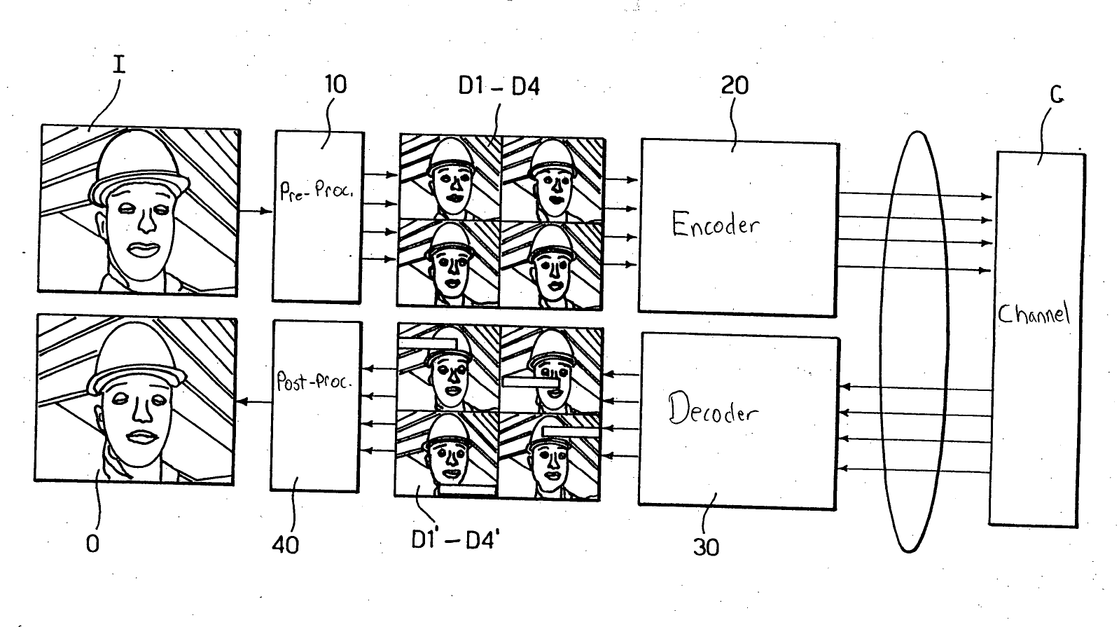

### BACKGROUND OF THE INVENTION

1. Field of the Invention

The present invention relates to techniques for dynamic adaptation of the speed of transmission of the bits, or bitrate, of a digital signal as a function of the bandwidth available for transmission.

The invention has been developed with particular attention paid to its possible application to video signals and/or to data flows distributed via networks such as satellite teletransmission networks, local streaming networks, and/or cellular networks for distribution of multimedia services.

Reference to said preferred contexts of possible application is not, however, to be interpreted as in any way limiting the scope of the invention.

2. Description of the Related Art

During distribution of a signal such as a video signal over a teletransmission network, the bitrate of the signal itself typically is dynamically modified so as to be adapted to the bandwidth currently available in the transmission network.

A substantially similar need can arise also at the level of recording/reproduction of the signal on/by a storage medium in the case of recording/reproduction systems characterized by a variable bandwidth. The term “transmission”, as used in the present description and in the ensuing claims, comprises in itself also said recording/reproduction operations.

Usually, the dynamic adaptation of the bitrate is obtained by means of real-time transcoders, which dynamically adapt the bitrate of the input data flows on the basis of the bandwidth available at output on the network. Real-time transcoders present the drawback of being very costly. This has lead to a search for alternative solutions to said basic approach.

A second technique of dynamic adaptation of the bitrate of data flows envisages having available, at input, a number of data flows encoded with different bitrates, and selecting from among these the flow having the highest bitrate compatible with the available band so as to exploit said band as well as possible.

A further known technique of dynamic adaptation of the bitrate is based upon scaleable data flows, which can be divided into a certain number of dependent layers, and envisages the operation of selecting the maximum number of layers that can be transmitted with the available bandwidth in order to exploit as extensively as possible said bandwidth.

The first layer is the basic layer, whilst the subsequent layers are perfectioning layers, which contain additional information as compared to the basic layer. In this case, the greater the number of layers that is transmitted, the greater the quality of the data flow transmitted.

### BRIEF SUMMARY OF THE INVENTION

Even though the various solutions described above, and in particular the ones mentioned last, are able to lead to results of use that are certainly satisfactory, there is still space for the development of further improved solutions.

One embodiment of the present invention a further improved solution by a method having the characteristics recalled in the ensuing claims. Some embodiments of the present invention relate also to a corresponding system, articulated in a transmission device and a receiving device, as well as a computer-program product that can be loaded into the memory of at least one computer and comprises portions of software code for implementing the aforesaid method. As used herein, reference to such a computer-program product is understood as being equivalent to reference to a computer-readable medium containing instructions for controlling a computer system in order to co-ordinate execution of the method according to the invention. Reference to “at least one computer” is intended to highlight the possibility for the present invention to be implemented in a distributed and/or modular way.

The claims form an integral part of the disclosure provided herein in relation to the invention.

A currently preferred embodiment of the invention envisages adapting the bitrate of a digital signal to the bandwidth available on a transmission channel via the operations of:

converting the digital signal into a multiple-description (MD) format, so as to have available a plurality of descriptions of the aforesaid digital signal; and

transmitting on said transmission channel descriptions of the digital signal chosen from among said plurality, the number of the descriptions transmitted being determined in a dynamic way as a function of the bandwidth available on the transmission channel.

The solution described herein is consequently based upon recourse to a multiple-description technique.

Techniques based upon multiple descriptions form the subject of an extensive scientific literature, as witnessed, for example, by the following studies:

P. C. Cosman, R. M. Gray, M. Vetterli, “Vector Quantization of Image Subbands: a Survey”, September 1995;

Robert Swann, “MPEG-2 Video Coding over Noisy Channels”, Signal Processing and Communication Lab, University of Cambridge, March 1998;

Robert M. Gray “Quantization”, IEEE Transactions on Information Theory, vol. 44, No. 6, October 1998, pp. 2325-2383;

Vivek K. Goyal, “Beyond Traditional Transform Coding”, University of California, Berkeley, Fall 1998;

Jelena Kovacevic, Vivek K. Goyal, “Multiple Descriptions—Source-Channel Coding Methods for Communications”, Bell Labs, Innovation for Lucent Technologies, 1998;

Jelena Kovacevic, Vivek K. Goyal, Ramon Arean, Martin Vetterli, “Multiple Description Transform Coding of Images”, Proceedings of IEEE Conf. on Image Proc., Chicago, October 1998;

Sergio Daniel Servetto, “Compression and Reliable Transmission of Digital Image and Video Signals”, University of Illinois at Urbana-Champaign, 1999;

Benjamin W. Wah, Xiao Su, Dong Lin, “A survey of error-concealment schemes for real-time audio and video transmission over internet”, Proceedings of IEEE International Symposium on Multimedia Software Engineering, December 2000;

John Apostolopoulos, Susie Wee, “Unbalanced Multiple Description Video Communication using Path Diversity”, IEEE International Conference on Image Processing (ICIP), Thessaloniki, Greece, October 2001;

John Apostolopoulos, Wai-Tian Tan, Susie Wee, Gregory W. Wornell, “Modeling Path Diversity for Multiple Description Video Communication”, ICASSP, May 2002;

John Apostolopoulos, Tina Wong, Wai-Tian Tan, Susie Wee, “On Multiple Description Streaming with Content Delivery Networks”, HP Labs, Palo Alto, February 2002, pp. 1 to 10;

John Apostolopoulos, Wai-Tian Tan, Susie J. Wee, “Video Streaming: Concepts, Algorithms and Systems”, HP Labs, Palo Alto, September 2002;

Rohit Puri, Kang-Won Lee, Kannan Ramchandran and Vaduvur Bharghavan, “Forward Error Correction (FEC) Codes Based Multiple Description Coding for Internet Video Streaming and Multicast”, Signal Processing: Image Communication, Vol. 16, No. 8, pp. 745-762, May 2001;

Rohit Puri and Kannan Ramchandran, “Multiple Description Source Coding Through Forward Error Correction Codes”, in the Proceedings of the 33rd Asilomar Conference on Signals, Systems, and Computers, Pacific Grove, Calif., October 1999; and

Rohit Puri, Kang-Won Lee, Kannan Ramchandran and Vaduvur Bharghavan, “Application of FEC based Multiple Description Coding to Internet Video Streaming and Multicast”, Proceedings of the Packet Video 2000 Workshop, Forte Village Resort, Sardinia, Italy, May 2000.

With specific reference to the patent literature, it is possible to cite, as general references on the subject, the documents Nos. WO-A-2004/057876, WO-A-2004/046879, WO-A-2004/047425, WO-A-2004/014083, WO-A-2003/005676, WO-A-2003/005677, WO-A-2003/0005761, WO-A-2004/032517, and WO-A-2004/056121.

### BRIEF DESCRIPTION OF THE DRAWINGS

The invention will now be described, by way of non-limiting example, with reference to the annexed plate of drawings, consisting of a single FIGURE, which represents, in the form of a block diagram, the general structure of a transmission system operating according to a multiple-description (MD) scheme.

### DETAILED DESCRIPTION OF THE INVENTION

The figure illustrates a multiple-description transmission system applied, for example, to the transmission of video digital signals.

An input video signal I is subjected to pre-processing in a module 10 so as to generate, for example, four descriptions D1 to D4. These are then passed on, to be “transmitted” on a channel C, to a transmitter module constituted by an encoder 20 (of any known type). This can be constituted by a transmission channel proper (for example, a channel comprised in a fixed/mobile network with a video streaming function) or by a recording medium (for example a tape, a disk, a digital memory, and so on) on which the encoded digital signals are written, to be then read even at a distance in time and space. The signals received after transmission on the channel C are sent on to a receiver module constituted by a decoder 30 to recover multiple descriptions D1′ to D4′, which are then merged in a post-processing module 40 to obtain an output video signal O.

The modules 10 and 20, on the one hand, and the modules 30 and 40, on the other, consequently form, respectively, a transmitter device and a receiver device, which is designed to receive the signal transmitted by the transmitter device.

As has already been said in the introductory part of the present description, the techniques based upon multiple descriptions form the subject of an extensive scientific literature. This renders superfluous any further detailed description thereof herein.

In particular, the number of multiple descriptions (here, by way of example, equal to four) can be any whatsoever. Indeed, the method described herein substantially envisages use of multiple descriptions (and, in particular, recourse to a variable number of multiple descriptions) to adapt the bitrate of the data flow I considered, for example, a video data flow, to the bandwidth available on the channel C.

The video is distributed by means of independent data flows. In order to be decoded and used, the n-th data flow does not require reception and decoding of the other data flows.

By way of example, a high-definition video can be split into four sub-sequences (for example the descriptions D1 to D4 in the figure of the attached plate of drawings) each having one fourth of the original resolution.

Consequently, each sub-sequence or description has a standard definition. Each description can at this point be compressed in the encoder 20 independently of the other descriptions or else it can be compressed jointly with the other descriptions. This encoding technique, mentioned by way of example, cannot be as efficient as the layer-coding technique but is much more robust in regard to errors.

If a given portion of a given frame is lost on account of the errors or of losses in a given data flow on the channel C, the corresponding “disturbance” can easily be masked on the basis of the same portion of the same frame in the other data flows.

The method described herein envisages the possibility of eliminating some descriptions at the transmitter end. Basically, the transmitter aims at transmitting the highest number of descriptions that it is possible to transmit using the currently available allocated bandwidth. The remaining descriptions are simply skipped; for example, it is possible to envisage that the encoder 20 will not encode the skipped descriptions, or else that the encoder will in any case encode all the descriptions, proceeding so that the ones that are to be skipped will simply then be erased.

A simple technique for skipping the descriptions envisages skipping the descriptions according to a particular order.

For example, if four descriptions D1 to D4 are available, and all have the same bitrate, an elementary strategy is the following:

the fourth description can be skipped to obtain a 25% reduction in the band occupied;

the fourth and the third descriptions can be skipped to obtain a 50% reduction in the band occupied; and

the fourth, the third, and the second descriptions can be skipped to obtain a 75% reduction in the band occupied.

The granularity of the reduction in the bandwidth depends upon the number of descriptions and upon the bitrate allocated for each of them.

It is, however, possible to obtain better levels of performance as compared to the elementary technique described previously, by choosing in a different way the descriptions to be skipped.

The above solution can be based upon the choice of skipping different descriptions at different instants. This solution is particularly indicated in the case where the descriptions have been obtained (in a known way) using the polyphase subsampling technique. If different descriptions are skipped at different instants, it is guaranteed that each pixel is refreshed within a certain time interval.

For example, if two descriptions are available with the same bitrate, a possible strategy envisages skipping alternately first one description and then the other, always obtaining a 50% reduction in the band occupied.

Two descriptions can be generated from a vertical polyphase subsampling technique, designated by 2:1, for example by separating the even rows from the odd rows. If the band is to be reduced by 50%, one description is skipped, by transmitting just the even rows or just the odd rows, operating alternately.

This solution presents for practical purposes some conceptual affinity with the scheme adopted by the old interlaced analog television, where the frame was split into two fields, one field for the even rows and one field for the odd rows and the fields were transmitted alternately in consecutive frames.

In this connection, as regards the coding parameters for the encoders of the descriptions to which the policy of choice described herein is applied, it may be noted that the video encoders are often based upon the prediction of the current image from one or more preceding images.

This means that, if one of the reference images were not available, because it has been lost during transmission or because it has not been transmitted by the transmitter, then also the images that have been compressed, transmitted and received correctly could not be decoded completely.

It is consequently important to operate in such a way that the policy of transmission adopted by the transmitter will be coordinated with the choice of the reference images in such a way that for each description at least those images are transmitted and, possibly, the others are skipped.

If, for example, I and P designate the reference images, and B the images constructed on the basis of said reference images, it is expedient that, in the case of two descriptions, the encoders should operate according to the following scheme:
frame: . . . 1, 2, 3, 4, 5, 6, 7, 8 . . .
encoding 1: . . . I, B, P, B, P, B, P, B . . .
encoding 2: . . . B, I, B, P, B, P, B, P . . .

The images of type B can be discarded by the transmitter without this implying any consequences for the decoding of the adjacent images since they are not used as reference for prediction. As is evident from the scheme, the images of type B are found to be intercalated. If the description (encoding) 1 corresponds to the even rows and the description (encoding) 2 to the odd rows, should the images B be discarded by the transmitter, the video would be intercalated. At the same time, the compressed and transmitted images would be decoded without errors due to the lack of reference images.

The solution described herein is suitable for being applied advantageously in the following way:

if there is no movement, the user will see a high-definition image; the even rows are transmitted with the frame N and the odd rows with the frame N+1; the reconstruction of the complete frame is possible via the simple juxtaposition of the two fields; and

if there is movement, the user will see a smooth movement: the even rows in the frame N and the odd rows in the frame N+1; this proves optimal in so far the human eye is less sensitive to spatial details when there is movement.

Occultation of the absence of pixels that belong to the skipped descriptions can be obtained following the same techniques of optimization adopted by the de-interlacers:

in the case where there is no movement, temporal occultation is preferable because temporal correlation is present;

in the case where there is movement, spatial occultation is preferable because no temporal correlation is present;

motion estimation/compensation can be used to verify temporal correlation where there is movement: this is a criterion for selection of temporal occultation;

edge detection can be used to find spatial correlation where there is no movement: this is a criterion for selection of spatial occultation.

The movement can be easily detected using the moduli of the motion vectors if the input data flows have said information included therein.

Currently used video encoders are based upon time prediction, also known as motion estimation and compensation: a data frame is predicted from weighted sums of blocks of pixels taken from reference frames and designated as motion vectors. If the modulus of said vectors is greater than a certain threshold, this indicates that there is movement.

Alternatively, the choice of the occultation method (designed to be implemented at the receiver end, usually upstream and/or downstream of the stage 40) that is most suitable can be made starting from the analysis of the technique of compression of the video data:

if the video-prediction data have been omitted and there is no movement, the pixels are static and temporally correlated; for occultation a low-pass temporal filter can simply be used;

if the video-prediction data have been compressed (in the encoder 20) using motion vectors and error prediction, then there is movement; motion estimation/compensation can be used for occultation, which exploits the knowledge of the motion vectors; alternatively, either a simple low-pass spatial filter or a low-pass spatial filter with edge recognition may be used;

if the video-prediction data have been compressed using the “intra” prediction technique, then the pixels present mild variations and are spatially correlated; either a low-pass spatial filter or a low-pass spatial filter with edge recognition may be used;

if the video-prediction data have been compressed using PCM intra techniques then the pixels cannot be either temporally or spatially predicted by the encoder: it is consequently not possible to identify optimal filters.

Analysis of how the video has been compressed takes into account the constraints of the encoder 20. For example, the pixels of “intra” images can usually be compressed just using methods of intra prediction or PCM intra methods. Hence, if the absence of the motion vectors does not indicate that there is no temporal correlation, the intra image can be correlated to the previous image. Said correlation can be calculated by the decoder performing a search (motion estimation) similar to the one performed in the encoder.

Each description can exploit the methods described previously: real-time transcoders, switching of the data flows, and layer coding.

The subsampled polyphase multiple descriptions can be created using a time-variable phase for each description, whereas normally the subsampling phase is fixed for each description.

If time-variable phase is used for the creation of the multiple descriptions, then a simple policy of elimination of the descriptions is transformed into a smart policy of elimination of the descriptions.

By way of non-limiting example, two specific possible embodiments are described hereinafter.

Subsampled polyphase multiple descriptions with fixed phase and smart policy of elimination of the descriptions: two descriptions are created by separating the even rows from the odd rows. Each description can be viewed as a progressive sequence. The descriptions are encoded independently so that each compressed description occupies one half of the available bitrate. To obtain a 50% reduction in the bitrate the first description is skipped for the frame number N, the second description is skipped for the frame number N+1, and again the first description is skipped for the frame N+2, and so forth.

Subsampled polyphase multiple descriptions with variable phase and simple policy of elimination of the descriptions: two descriptions are created by separating the even rows from the odd rows. The first description comprises the odd rows of the odd frames and the even rows of the even frames. The second description comprises the even rows of the odd frames and the odd rows of the even frames. Each description can be viewed as an interlaced sequence. The descriptions are encoded independently so that each compressed description occupies one half of the available bitrate. To obtain a 50% reduction in the bitrate, the first description is skipped for each frame.

On the basis of the solution described, it may be evinced that the presence of a real-time transcoder, which is very costly, is consequently not necessary, and, furthermore, it is not necessary to have at input a number of different data flows encoded with different bitrates.

As compared to layer coding, the solution described herein is more robust to losses and presents a reduced encoding efficiency.

Consequently, without prejudice to the principle of the invention, the details of implementation and the embodiments may vary, even significantly, with respect to what is described and illustrated herein, purely by way of non-limiting example, without thereby departing from the scope of the invention, as defined in the ensuing claims.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

1. A method for adapting a bitrate of a digital signal to a bandwidth available on a transmission channel, of the method comprising:
converting said signal into a multiple-description format, so as to have available a plurality of descriptions of said digital signal; and
transmitting on said transmission channel descriptions of said digital signal chosen from among said plurality of descriptions, the number of said descriptions transmitted being determined in a dynamic way as a function of the bandwidth available on said transmission channel.

2. The method according to claim 1, further comprising encoding said descriptions of said digital signal independently of one another.

3. The method according to claim 1, further comprising encoding said descriptions of said digital signal in a way dependent upon one another.

4. The method according to claim 1, further comprising selecting said number of transmitted descriptions so as to maximize the use of the bandwidth available on said transmission channel.

5. The method according to claim 1, further comprising skipping, omitting transmission thereof, at least one of the descriptions to obtain a reduction in the bandwidth occupied on said transmission channel.

6. The method according to claim 5, wherein the skipping step includes skipping the descriptions following a given order.

7. The method according to claim 5, wherein the skipping steps includes varying in time which of said at least one of the descriptions is skipped to obtain a reduction of the bandwidth occupied on said transmission channel.

8. The method according to claim 1, wherein:
the converting step includes converting said signal into a sequence of reference images and of prediction images constructed based on said reference images; and
the transmitting step includes transmitting, for each of said multiple descriptions, at least said reference images, possibly skipping said prediction images.

9. The method according to claim 1, further comprising:
receiving the descriptions of said digital signal transmitted on said channel; and
reconstructing said digital signal from said descriptions transmitted on said channel.

10. The method according to claim 9, wherein the reconstructing includes hiding an error caused by skipping at least one of the descriptions of said plurality.

11. The method according to claim 10, wherein the hiding step includes applying a method of temporal occultation of the error when a temporal correlation is present between said descriptions transmitted on said channel.

12. The method according to claim 11, wherein said method of temporal occultation uses a low-pass temporal filter.

13. The method according to claim 10, wherein the hiding step includes applying a method of spatial occultation of the error when a spatial correlation is present between said descriptions transmitted on said channel.

14. The method according to claim 13, wherein said method of spatial occultation uses a low-pass spatial filter or a low-pass spatial filter with edge recognition.

15. The method according to claim 1, wherein the converting step includes creating said descriptions using a subsampling phase that is variable in time for each description.

16. A device for adapting a bitrate of a digital signal to a bandwidth available on a transmission channel, the device comprising:
a processing module configured for converting said signal into a multiple-description format, so as to have available a plurality of descriptions of said digital signal; and
a transmission module configured for transmitting on said transmission channel descriptions of said digital signal chosen from among said plurality of descriptions, the number of said transmitted descriptions being determined in a dynamic way as a function of the bandwidth available on said transmission channel.

17. The device according to claim 16, further comprising an encoder configured for encoding said descriptions of said digital signal independently of one another.

18. The device according to claim 16, further comprising an encoder configured for encoding said descriptions in a way dependent on one another.

19. The device according to claim 16, wherein said transmission module is configured for selecting said number of transmitted descriptions so as to maximize the use of the bandwidth available on said transmission channel.

20. The device according to claim 16 wherein said transmission module is configured for skipping, omitting transmission thereof, at least one of the descriptions to obtain a reduction of the bandwidth occupied on said transmission channel.

21. The device according to claim 20, wherein said transmission module is configured for skipping the descriptions following a given order.

22. The device according to claim 20, wherein said transmission module is configured for varying in time the choice of said at least one of the descriptions skipped to obtain a reduction of the bandwidth occupied on said transmission channel.

23. The device according to claim 16, wherein said processing module is configured for creating said descriptions using a phase of subsampling that is variable in time for each description.

24. The device according to claim 16 wherein said transmission module is configured for:
converting said signal into a sequence of reference images and of prediction images constructed based on said reference images; and
transmitting, for each of said multiple descriptions, at least said reference images, possibly skipping said prediction images.

25. A receiving device for receiving a transmitted signal transmitted by a transmitting device that includes a transmitter processing module configured for converting an input digital signal into a multiple-description format, so as to have available a plurality of descriptions of said input digital signal; and a transmission module configured for transmitting on said transmission channel descriptions of said input digital signal chosen from among said plurality of descriptions, the number of said transmitted descriptions being determined in a dynamic way as a function of a bandwidth available on a transmission channel, the receiving device comprising:
a receiving module configured for receiving the transmitted descriptions of said transmitted signal; and
a receiver processing module configured for reconstructing said input digital signal from said transmitted descriptions.

26. The receiving device according to claim 25, wherein said receiver processing module is configured for reconstructing said input digital signal from said transmitted descriptions by hiding an error caused by skipping at least one of the descriptions of said plurality.

27. The receiving device according to claim 26, said receiver processing module is configured for applying a process of temporal occultation of the error when a temporal correlation is present between said descriptions transmitted on said channel.

28. The receiving device according to claim 26, wherein said receiver processing module is configured for applying a process of spatial occultation of the error when a spatial correlation is present between said descriptions transmitted on said channel.

29. The receiving device according to claim 27, wherein said receiver processing module comprises a low-pass temporal-occultation filter.

30. The receiving device according to claim 28, wherein said receiver processing module comprises a low-pass spatial-occultation filter or a low-pass spatial-occultation filter with edge recognition.

31. A computer-readable medium including program code that, when loaded into a memory of at least one computer, causes the at least one computer to perform a method comprising:
converting a digital signal into a multiple-description format, so as to have available a plurality of descriptions of said digital signal; and
transmitting on a transmission channel descriptions of said digital signal chosen from among said plurality of descriptions, the number of said descriptions transmitted being determined in a dynamic way as a function of a bandwidth available on said transmission channel.

32. The computer-readable medium of claim 31 wherein the program code causes the at least one computer to encode the descriptions being transmitted independently of one another.

33. A method, comprising:
receiving a transmitted signal that includes a selected plurality of descriptions, the selected plurality of descriptions being a first subset of a plurality of descriptions of a multiple-description format signal that was converted from an original signal;
reconstructing said original signal from said selected plurality of descriptions.

34. The method according to claim 33, wherein the reconstructing includes hiding an error caused by skipping a second subset of the plurality of descriptions.

35. The method according to claim 34, wherein the hiding step includes applying a method of temporal occultation of the error when a temporal correlation is present between said descriptions transmitted on said channel.

36. The method according to claim 35, wherein said method of temporal occultation uses a low-pass temporal filter.

37. The method according to claim 34, wherein the hiding step includes applying a method of spatial occultation of the error when a spatial correlation is present between said descriptions transmitted on said channel.

38. The method according to claim 37, wherein said method of spatial occultation uses a low-pass spatial filter or a low-pass spatial filter with edge recognition.
